(19) United States
(12) Patent Application Publication
(10) Pub. No.: US 2023/0415190 A1
(43) Pub. Date: Dec. 28, 2023

(54) FLOATING WATERSCAPE APPARATUS

(71) Applicant: Shenzhen Xiaoyuluo Technology Co., Ltd, Ganzhou (CN)

(72) Inventor: Xianyan Ning, Shenzhen (CN)

(21) Appl. No.: 18/177,222

(22) Filed: Mar. 2, 2023

(30) Foreign Application Priority Data
Jun. 22, 2022 (CN) 202221580679.2
Jun. 22, 2022 (CN) 202221589709.6

(51) Int. Cl. B05B 17/08; H02S 20/30

(52) U.S. Cl. CPC B05B 17/08; H02S 20/30

(57) ABSTRACT

A floating waterscape apparatus having a floating body, at least one power generation module and a water spraying component is disclosed. Each power generation module comprises at least one first photovoltaic unit, and each first photovoltaic unit protrudes from the floating body and has a gap with the floating body when the power generation module is installed on the floating body; each power generation module being installed on the floating body and powered by the first photovoltaic unit; wherein the floating body causes at least part of the first photovoltaic unit to be above the water surface and at least part of the water spraying component to be below the water surface. Through a plurality of first photovoltaic units independent of the floating body to supply power to the water spraying component, the floating waterscape apparatus can be made more shapes.

### TECHNICAL FIELD

The present disclosure relates generally to a waterscape decoration technical field, and more particularly relates to a floating waterscape apparatus.

### BACKGROUND

The fountain is a waterscape used to spray various beautiful water postures in the artificial pool or natural water body for people to watch. In modern gardens, the fountain is an important landscape besides plant landscape, and the fountain is also a waterscape art. Meanwhile, the tiny water droplets of the fountain collide with the air molecules, which can produce a large number of negative oxygen ions, increase air humidity, reduce environmental temperature, and so on. Thus, the fountain is deeply loved by people.

Most kinds of the existing fountain are fixed underwater and connected to external power supply through cables, which has certain potential safety hazards. In addition, the above fountains are often huge and difficult to install, maintain and disassemble. They are not suitable for some small-scale scenic spots, pools or basins of ordinary families (such as bird bath tray).

The floating solar fountain converts solar energy into electric energy directly, and can spray water without external power supply, without operating costs. At the same time, the floating solar fountain completely eliminates the potential safety hazards of external power supply, needs not to lay power supply cables, and also greatly reduces the maintenance cost. However, the existing floating solar fountains usually fix all solar cells on a circular disk, which is not only simple in shape, but also wasting a large amount of substrate of the solar cells between the circular disks when the circular disk is cut from the rectangular substrate during the production process.

### SUMMARY

The present disclosure has provided a floating waterscape apparatus, aiming at the technical problem that the existing solar energy floating fountain fix all solar cells on a circular disk, thus resulting in a single shape and waster substrate.

According to an aspect, a floating waterscape apparatus is provided, which comprising a floating body;
at least one power generation module, each of which comprising at least one first photovoltaic unit for converting light energy into electric energy, wherein the first photovoltaic unit protrudes from the floating body and has a gap with the floating body when the power generation module is installed on the floating body;
a water spraying component, which being installed on the floating body and powered by the first photovoltaic unit directly or indirectly, wherein the floating body causes at least part of the first photovoltaic unit to be above the water surface and at least part of the water spraying component to be below the water surface when the floating body is placed in the water.

Advantageously, the floating waterscape apparatus contains a plurality of power generation modules; wherein the floating body comprises a main housing and a plurality of support arms protruding from the outer circumference of the main housing, and the number of the support arms is greater than or equal to the number of the power generation modules; wherein each of the power generation module is assembled on one support arm through a fastener.

Advantageously, the main housing contains an internal cavity, a water inlet and a water outlet, and the water inlet and the water outlet are joined with the internal cavity respectively, wherein the water outlet is above the water surface and the water inlet is below the water surface when the floating body is placed in the water;
wherein the water spraying component comprises a control circuit board and a submersible pump, and the submersible pump and the first photovoltaic unit are electrically connected with the control circuit board respectively; wherein the submersible pump and the control circuit board are installed in the internal cavity of the main housing, and the water entering the internal cavity through the water inlet is sprayed out from the water outlet by the submersible pump.

Advantageously, the free end of at least one support arm is provided with a fixed base with LED lamps installed in it, and the top of the fixed base is provided with a vertical mounting hole;
wherein the fastener comprises a rod part and a top cover connected with the top of the rod part; wherein the rod part is hollow and tubular, and the top cover is formed with transparent or translucent materials; each power generation module is provided with a through hole, and the fastener assembles the power generation module to the support arm by the rod part passing through the through hole and inserting into the mounting hole on the fixed base when the power generation module is put on the fixed base.

Advantageously, the floating body contains an annular foam unit with a central through-hole, wherein the annular foam unit is fixed under the support arms, and a part of the main housing inserts into the central through-hole of the annular foam unit.

Advantageously, the floating waterscape apparatus contains one power generation module, and the first photovoltaic unit is annular; alternatively, the floating waterscape apparatus comprises a plurality of power generation modules, and the first photovoltaic units of the plurality of power generation modules are spliced into a ring.

Advantageously, the floating waterscape apparatus contains one power generation component;
wherein the floating body comprises one main housing and one support arm protruding from the top of the main housing, and the power generation module is assembled on the top of the support arm.

Advantageously, the main housing contains an internal cavity, a water inlet and a water outlet, and the water inlet and the water outlet are joined with the internal cavity respectively; wherein the water outlet is above the water surface and the water inlet is below the water surface when the floating body is placed in the water;
wherein the water spraying component is installed in the internal cavity of the main housing, and the water entering the internal cavity through the water inlet is sprayed out from the water outlet by the water spraying component.

Advantageously, the floating body contains an annular foam unit with a central through-hole, the main housing is fastened to the annular foam unit with a plurality of support feet, and a part of the main housing inserts into the central through-hole of the annular foam unit.

Advantageously, each power generation module contains a plurality of first photovoltaic units, and the plurality of first photovoltaic units are radially distributed around the fixed position of the power generation module and the floating body.

Advantageously, the floating waterscape apparatus contains a plurality of power generation modules and a plurality of pivot connectors;
wherein each of the power generation components is assembled to the floating body through one of the pivot connectors; each pivot connector includes a pivot part, and the first photovoltaic unit of each power generation module adjusts its position by rotating around the pivot part of the pivot connector.

Advantageously, the floating body is provided with a limiting structure which limits the power generation module rotating between a first position and a second position, wherein the first photovoltaic unit is stacked above the floating body when the power generation module is at the first position, and the first photovoltaic unit is protruded from the periphery of the floating body when the power generation module is at the second position.

Advantageously, the floating body includes a main housing and a plurality of support arms protruding from the outer circumference of the main housing, and each of the power generation modules is assembled on one of the support arms through a pivot connector.

Advantageously, the main housing contains an internal cavity, a water inlet and a water outlet, and the water inlet and the water outlet are joined with the internal cavity respectively; wherein the water outlet is above the water surface and the water inlet is below the water surface when the floating body is placed in the water;
wherein the water spraying component is installed in the internal cavity of the main housing, and the water entering the internal cavity through the water inlet is sprayed out from the water outlet by the water spraying component.

Advantageously, the rotation center of the pivot part of each pivot connector is located on the same cylindrical surface centered on the central axis of the main housing, and the rotation centers of the pivot parts of the plurality of the pivot connectors are respectively parallel to the central axis of the main housing.

Advantageously, at least one of the power generation modules contains a second photovoltaic unit assembled on the floating body;
wherein each of the second photovoltaic units includes a second photovoltaic cell that supplies power to the water spraying component, and the second photovoltaic cell is above and parallel to the water surface when the floating body is placed in the water.

Advantageously, each second photovoltaic unit and one first photovoltaic unit are assembled to the same position of the floating body through a same pivot connector.

Advantageously, at least one of the power generation modules includes a third photovoltaic unit, and each third photovoltaic unit contains a first interface;
wherein at least one of the first photovoltaic units includes a second interface, and each third photovoltaic unit is assembled to one first photovoltaic unit through the first interface and the second interface, the third photovoltaic unit supplies power to the water spraying module through the first interface and the second interface.

Advantageously, the free end of at least one support arm is provided with a fixed base with LED lamps installed in it, and the top of the fixed base is provided with a vertical mounting hole;
wherein each pivot connector comprises a rod part and a top cover on the top of the rod part; wherein the rod part is hollow and tubular, and the top cover is formed with transparent or translucent materials; each power generation module is provided with a through hole, and the pivot connector assembles the power generation module to the support arm by the rod part passing through the through hole and inserting into the mounting hole on the fixed base.

Advantageously, the floating body contains an annular foam unit with a central through-hole, and the annular foam unit is fixed under the support arms, and a part of the main housing inserts into the central through-hole of the annular foam unit.

The floating waterscape apparatus disclosed in the present disclosure has following beneficial effect. The floating waterscape apparatus can be made more shapes by using a plurality of first photovoltaic units independent of the floating body to supply power to the water spraying component. Meanwhile, the volume of each first photovoltaic unit is relatively small for the plurality of first photovoltaic units are independent, thus reducing the waste of substrate during production.

### BRIEF DESCRIPTION OF THE DRAWINGS

FIG. 1 is a schematic diagram of the floating waterscape apparatus according to an embodiment of the present disclosure.

FIG. 2 is the sectional structure diagram of the floating waterscape equipment shown in FIG. 1;

FIG. 3 is a decomposition diagram of the floating waterscape apparatus according to an embodiment of the present disclosure.

FIG. 4 is a decomposition diagram of the main housing in the floating waterscape apparatus according to an embodiment of the present disclosure.

FIG. 5 is a decomposition diagram of the power generation module in the floating waterscape apparatus according to an embodiment of the present disclosure.

FIG. 6 is a schematic diagram of the floating waterscape apparatus according to another embodiment of the present disclosure.

FIG. 7 is a schematic diagram of the floating waterscape apparatus according to another embodiment of the present disclosure.

FIG. 8 is a schematic diagram of the floating waterscape apparatus according to another embodiment of the present disclosure.

FIG. 9 is the sectional structure diagram of the floating waterscape apparatus shown in FIG. 8.

FIG. 10 is a schematic diagram of the floating waterscape apparatus according to another embodiment of the present disclosure.

FIG. 11 is a schematic diagram of the floating waterscape apparatus shown in FIG. 10 when the first photovoltaic unit is in the first position.

FIG. 12 is a sectional structure diagram of the floating waterscape apparatus along line A-A shown in FIG. 11.

FIG. 13 is a decomposition diagram of the main housing and the first photovoltaic unit in the floating waterscape apparatus shown in FIG. 10.

FIG. 14 is a schematic diagram of the floating waterscape apparatus according to another embodiment of the present disclosure.

FIG. 15 is a schematic diagram of the floating waterscape apparatus according to another embodiment of the present disclosure.

FIG. 16 is an assembly structure diagram of the first photovoltaic unit and the third photovoltaic unit in the floating waterscape apparatus shown in FIG. 15;

FIG. 17 is another assembly structure diagram of the first photovoltaic unit and the third photovoltaic unit in the floating waterscape apparatus shown in FIG. 15.

### DETAILED DESCRIPTION OF THE PREFERRED EMBODIMENT

To make the object, the technical solution, and the advantage of the present disclosure more clearly, the present disclosure is further described in detail below with reference to the accompanying embodiments. It should be understood that the specific embodiments described herein are just a part of rather than all the embodiments of the present disclosure. All other embodiments obtained by one skilled in the art without inventive works based on the embodiment of the present disclosure, fall into the protection scope of the present disclosure.

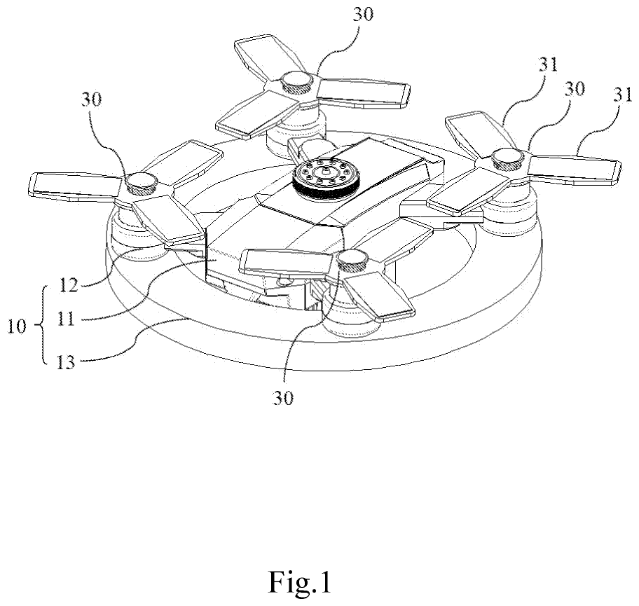

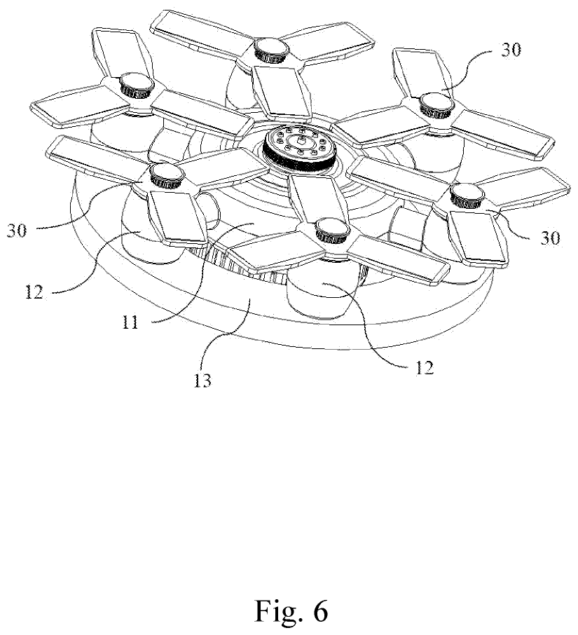

FIG. 1 is a schematic diagram of the floating waterscape apparatus according to an embodiment of the present disclosure. The floating waterscape apparatus as shown in FIG. 1 can be applied to the garden landscape, water pool, bird bath tray, etc. to improve the visual effect. The floating waterscape apparatus according to the present embodiment includes a floating body 10, a water spraying component 20 and four power generation modules 30. Each power generation module 30 includes three first photovoltaic units 31 for converting light energy into electric energy. In practical applications, the number of the power generation modules 30 and the number of the first photovoltaic units 31 in each power generation module 30 can be different according to the size of the floating body 10, the rated power of the water spraying component 20, the size of the first photovoltaic unit 31, etc. For example, in the embodiment of FIG. 6, as the floating body 10 is big, the floating waterscape apparatus is equipped with six power generation modules 30, each of which comprises three first photovoltaic units 31.

The first photovoltaic unit 31 mentioned above comprises one or more photovoltaic cells and substrates, wherein the photovoltaic cells and substrates are same as those of the photovoltaic cells and substrates in the prior art. The first photovoltaic unit 31 can output electric energy when exposed to sunlight, etc., and each first photovoltaic unit 31 is electrically connected with the water spraying component 20 and supplies power to the water spraying component 20. The first photovoltaic units 31 protrudes from the floating body 10 and has a gap 51 with the floating body 10 when the water spraying component 20 and the power generation module 30 are installed on the floating body 10. The overall density of the floating body 10 is less than that of the water, and it can bear the water spraying component 20 and the power generation modules 30 to float on the water surface 52 together. When the floating body 10 is placed in the water, the floating body 10 will make a part or all of the first photovoltaic units 31 above the water surface 52 and a part of the water spraying component 20 below the water surface 52. That is, the water spraying component 20 will be assembled to the lower part of the floating body 10, and the generator modules 30 is assembled to the upper part of the floating body 10. Thus, the water spraying component 20 powers by each first photovoltaic unit 31, and sprays the water below the water surface to the upper of the water surface. Moreover, in order to improve the efficiency of power generation, it is better that all the first photovoltaic units 31 are located above the water surface.

In the above floating waterscape apparatus, the water spraying component 20 powers by multiple independent first photovoltaic units 31 in power generation module 30, and the volume of each first photovoltaic unit 31 is relatively small. Thus, waste of substrate is reduced. At the same time, the floating waterscape apparatus can be made more shapes for each power generation module 30 protrudes from the floating body 10.

In an embodiment of the present disclosure, the floating body 10 includes a main housing 11 and four support arms 12 as the floating waterscape apparatus includes four power generation modules 30. The number of the support arms 12 can be different as needed. In this embodiment, the number of support arms 12 is the same as the number of power generation modules 30. The support arms 12 and the main housing 11 can be an integrated structure. The central axis of the main housing 11 consists of the central axis of the floating body 10. Each support arm 12 protrudes from the outer circumference of the main housing 11, and the four power generation modules 30 are respectively fixed to the support arms 12 by fasteners 35. In order to make the first photovoltaic unit 31 above the water surface when the floating body 10 is placed in the water, each power generation module 30 can be fixed to the top of the corresponding support arm 12.

Moreover, the support arms 12 are radially distributed around the center of the main housing 11. That is, the central axis of each support arms 12 is located on the same cylindrical surface 53 with the center axis 54 of the main housing 11, and the central axis of each support arm 12 is parallel to the central axis of the main housing 11. Thus, the stability of floating waterscape apparatus floating on the water is improved.

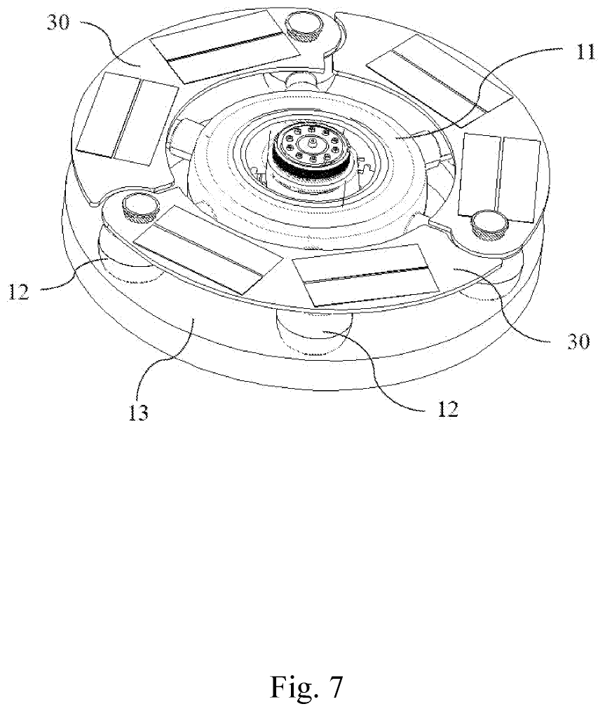

As shown in FIG. 7, the number of support arms 12 can also be greater than the number of the power generation modules 30. The power generation modules 30 is fixed to the top of several support arms 12.

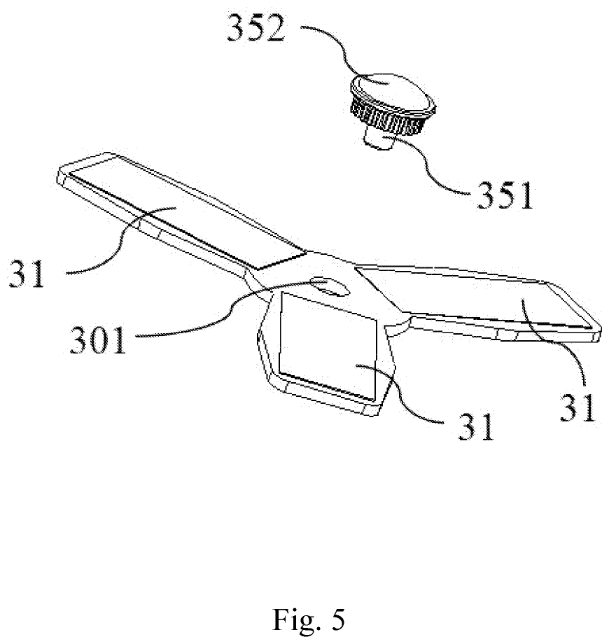

As shown in FIG. 5, multiple first photovoltaic units 31 of each power generation module 30 can be distributed radially. When the floating body 10 is placed in the water, the plane of each first photovoltaic unit 31 is located above and parallel to the water surface. In other embodiments, all first photovoltaic units 31 can be located in the same plane or in different planes.

The weight of the floating body 10 can be reduced through the above structure of the main housing 11 and the support arms 12. Of course, the main housing 11 can also be disk-shaped in other embodiments. But the weight of the main housing will also increase when the volume of the main housing 11 is large.

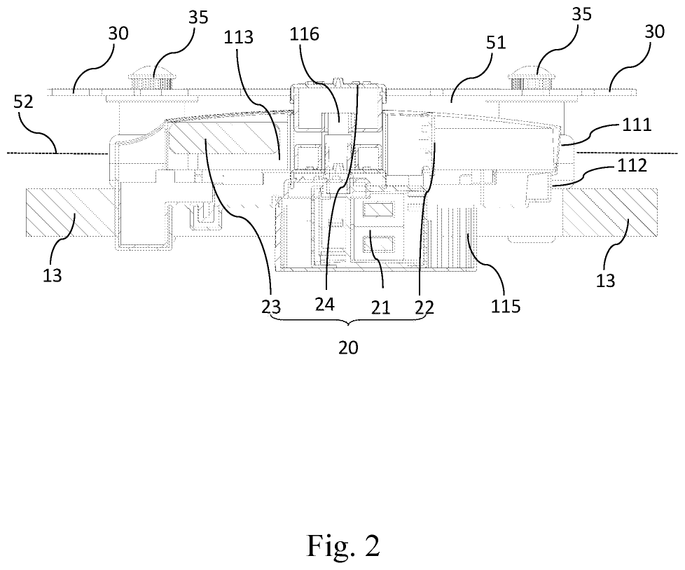

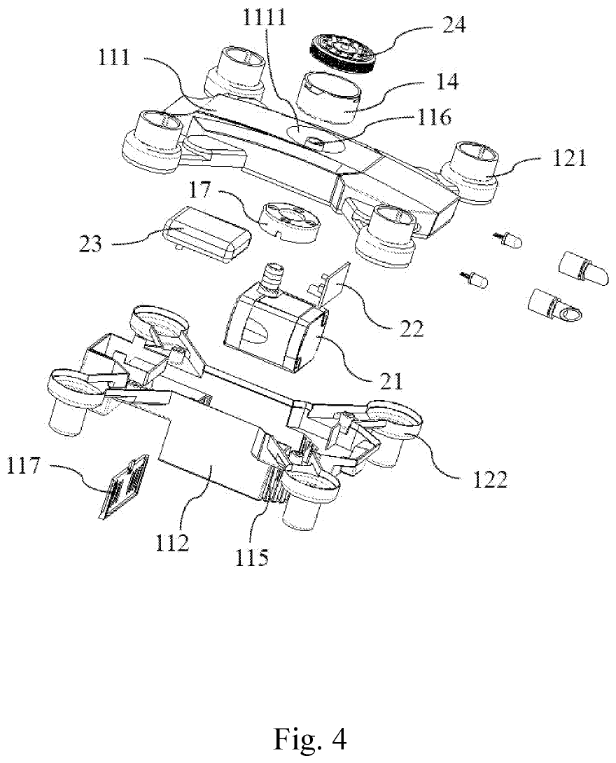

As shown in FIGS. 2 and 4, the main housing 11 of the floating body 10 includes an upper shell 111 and a lower shell 112. The upper shell 111 and the lower shell 112 can be fixed together, and an internal cavity 113 is formed between the upper shell 111 and the lower shell 112. The internal cavity 113 includes water inlet 115 and water outlet 116. When the floating body 10 is placed in the water, the water outlet 116 is above the water surface and the water inlet 115 is below the water surface. Specifically, the water inlet 115 can be consisted of a hollow grid located on the side of the lower shell 112, and the water outlet 116 can be located on the top of the upper shell 111.

Specifically, each support arm 12 is formed by the combination of an upper arm shell 121 and a lower arm shell 122 , and a channel is formed between the upper arm shell 121 and the lower arm shell 122 that is joined with the internal cavity 113 and used for the passage of cables. The upper arm shell 121 is integrated with the upper shell 111 and protrudes from the outer circumference of the main part of the upper shell 111. The lower arm shell 122 is integrated with the lower shell 112 and protrudes from the outer circumference of the main part of the lower shell 112. Of course, in other embodiments, each support arm 12 can also use an independent component and be assembled to the main housing 11.

In an embodiment of the present disclosure, the water spraying component 20 includes a submersible pump 21, a control circuit board 22 and a rechargeable battery 23. The submersible pump 21 and the rechargeable battery 23 are electrically connected with the control circuit board 22 respectively. The first photovoltaic unit 31 is electrically connected with the control circuit board 22 by cables (not shown in the figure) passing through the channel in the support arm 12. The submersible pump 21, the control circuit board 22 and the rechargeable battery 23 are all installed in the internal cavity 113. Accordingly, there are corresponding mounting holders for mounting the submersible pump 21, the control circuit board 22 and the rechargeable battery 23 in the internal cavity 113. The mounting holders for mounting the control circuit board 22 and the rechargeable battery 23 are located in the upper shell 111, and the control circuit board 22 and the rechargeable battery 23 can be fixed by glue to increase the waterproof performance. The mounting holders for mounting the submersible pump 21 are located in the lower shell 112. When the floating body 10 is placed in the water, the external water flows into the internal cavity 113 through the water inlet 115, and the water that enters into the internal cavity 113 through the water inlet 115 is sprayed out from the outlet 116 by the submersible pump 21. Thus a waterscape is formed. In other embodiments, the control circuit board 22 and the rechargeable battery 23 can also be integrated into the submersible pump 21 to reduce subsequent assembly and wiring operations.

In other embodiments, the water spraying component 20 can also use any existing device or combination of devices that can spray water.

On the control circuit board 22, there are a charging circuit and a power supply circuit (such as a DC motor drive circuit). The first photovoltaic unit 31 is electrically connected with the rechargeable battery 23 via the charging circuit. The charging circuit outputs the electric energy generated by the first photovoltaic unit 31 to the charging battery 23 for storing. The power supply circuit is powered by the rechargeable battery 23 and output the electric energy to the submersible pump 21. The structure and connection of the submersible pump 21, the control circuit board 22 and the rechargeable battery 23, as well as the control of the water spraying process, belong to the familiar technology in the art, and will not be described here. In other embodiments, there is no rechargeable battery 23 in the water spraying component 20, and the first photovoltaic unit 31 directly supplies power to the power supply circuit on the control circuit board 22. But in these embodiments, it will cause the water spray of the submersible pump 21 to be unstable and the water spray time to be short (the water spray will be stopped when there is no light).

In another embodiment, the water spraying component 20 also includes a nozzle 24. Accordingly, the floating body 10 includes a mounting ring 14. At the same time, an mounting slot 1111 is set on the top surface of the upper shell 111, and the water outlet 116 is located in the mounting slot 1111. The installation ring 14 is fixed to the mounting slot 1111 by tight fitting or adhesive method. The nozzle 24 is locked and fixed to the installation ring 14 by clamping, threaded connection, etc. The bottom end of the nozzle 24 is connected with the water outlet 116. Through the nozzle 24, the visual effect of water spray can be improved. For example, multiple streams of small water columns sprayed in different directions can be formed. The structure of nozzle 24 can use the familiar technology in the art, and will not be described here.

In another embodiment, a light-emitting module 17 is set under the mounting slot 1111. The light-emitting module 17 is electrically connected with the control circuit board 22, and is driven by the drive circuit on the control circuit board 22 to emit light. The light emitted by the light-emitting module 17 shines upward through the mounting slot 1111, so that the water column sprayed from the nozzle 24 has a variety of colors. The structure and control logic of the light-emitting module 17 belong to the familiar technology in the art, and will not be described here.

In other embodiments, the main housing 11 is flat. Accordingly, the submersible pump 21, the control circuit board 22 and the rechargeable battery 23 are fixed on the bottom of the main housing 11.

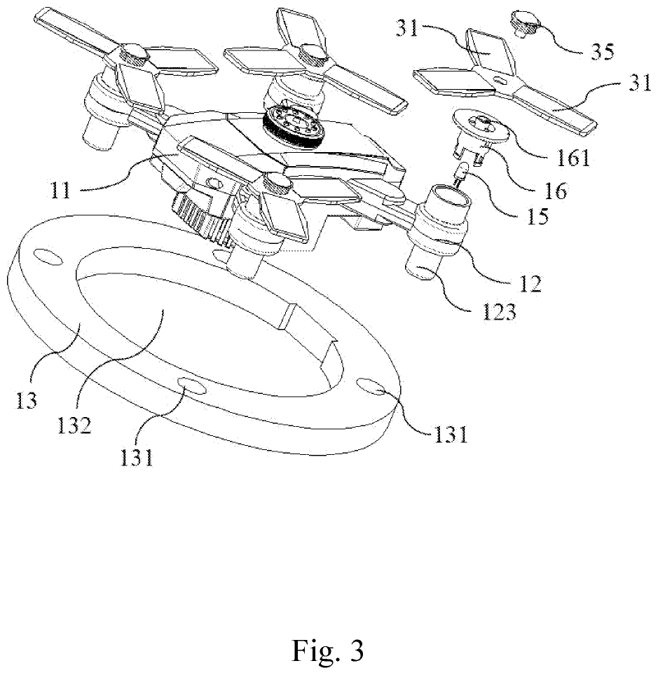

In another embodiment, as shown in FIG. 3, in order to improve the visual effect, LED lamp beads 15 and mounting bases 16 for mounting LED lamp beads 15 are fixed on some support arms 12. That is, at least part of the free end of the support arms 12 are provided with the mounting bases 16 and LED lamp beads 15. Each LED lamp bead 15 is fixed in a mounting base 16 by potting. Each mounting bases 16 is fixed on the upper shell 121 of the support arm 12 through a buckle. The LED lamp beads 15 are electrically connected with the drive circuit on the control circuit board 22 through cables passing through the channel of the support arm 12, and are powered by the rechargeable battery 23.

The mounting base 16 is provided with a vertical mounting hole 161 on the top. As shown in FIG. 5, the fastener 35 used to fixing the generation module 30 to the floating body 10 contains a rod part 351 and a top cover 352 connected to the top of the rod part 351. The rod part 351 is hollow and tubular. The top cover 352 is formed with transparent or translucent materials. Each power generation module 30 includes a through hole 301. For example, the through hole 301 is located at the geometric center of the power generation module 30. The rod part 351 of the fastener 35 passes through the through hole 301 and is inserted into the mounting hole 161 on the mounting base 16. The rod 351 and the mounting hole 161 can be fixed by tight fitting, thread connection, buckle connection or glue bonding. In this way, the light emitted by the LED bead 15 can be emitted from the top cover 352 through the mounting hole 161 and the rod part 351. Thus a good visual effect is presented.

In another embodiment, an operation window and a cover plate 117 for sealing the operation window are set on the main housing 11. For example, the operation window is set on the lower shell 112, and the cover plate 117 is installed on the main housing 11 by bolt fixation, snap and other removable methods. Through the operation window, the water spraying component 20 in the internal cavity 113 can be maintained, such as wiring, cleaning the submersible pump 21, etc. Of course, in other embodiments, the operation window and cover plate 117 may not be set on the main housing 11.

In another embodiment, the floating body 10 also includes an annular foam unit 13 with a central through-hole 132. The annular foam unit 13 is fixed below the support arm 12. A part of the main housing 11 (such as the part of the submersible pump 21 located) passes through the central through-hole 132 of the annular foam unit 13 and extends below the bottom surface of the annular foam unit 13. The density of the annular foam unit 13 is less than that of water, and the floating body 10 is floating in the water mainly by the buoyancy provided by the annular foam unit 13. Specifically, the lower part of each support arm 12 is provided with a cylindrical part 123, and the annular foam unit 13 is provided with a fixing hole 131 corresponding to the cylindrical part 123. The cylindrical part 123 is inserted into the fixing hole 131 from the upper part of the annular foam unit 13 and is tightly matched with the annular foam unit 13 or fixed by adhesive. Of course, in other embodiments, the cylindrical part 123 can also be fixed with the annular foam unit 13 by means of a stud structure. In addition, the annular foam unit 13 can also adopt other shapes and can be installed and fixed on the main housing 11, but it may affect the stability of the floating body 10 in the water.

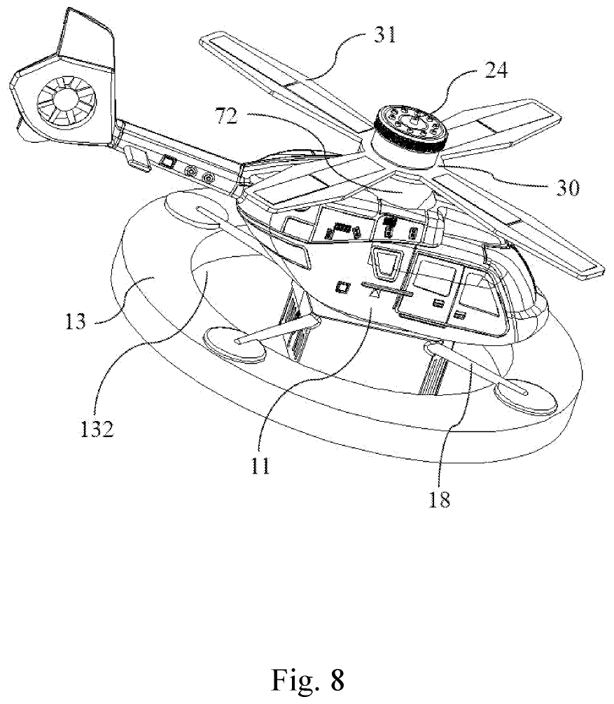

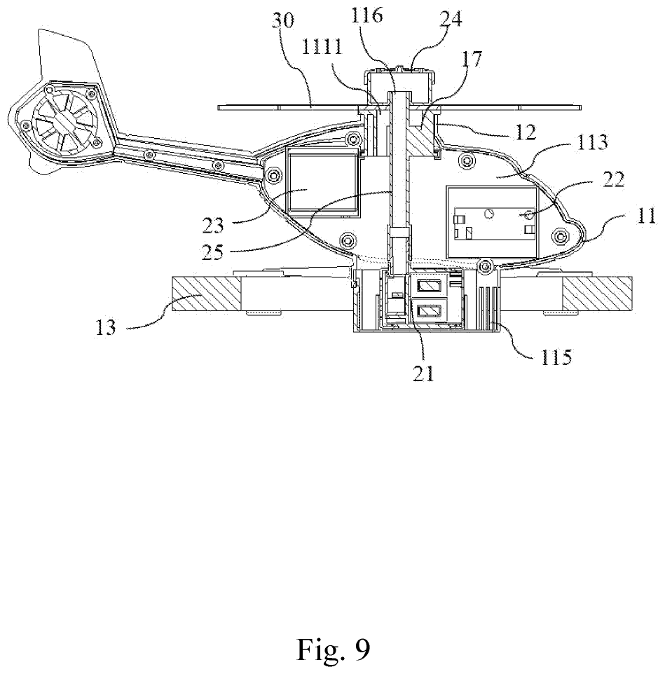

As shown in FIGS. 8-9, in another embodiment of the present disclosure, the floating waterscape apparatus includes one power generation module 30, which includes four first photovoltaic units 31. Of course, the number of the first photovoltaic units 31 in the power generation module 30 can be increased or decreased as needed. Accordingly, the top of the main housing 11 of the floating body 10 is provided with one support arm 12, and the power generation module 30 is assembled on the top of the support arm 12. For example, the main housing 11 is assembled from a left shell and a right shell. When the floating body 10 is placed in the water, the plane of the first photovoltaic units 31 is located above the water surface.

In another embodiment of the present disclosure, the main housing 11 includes only one support arm 12 which is located above the internal cavity 113. Similar to the embodiment in FIG. 1, the internal cavity 113 includes a water inlet 115 and a water outlet 116. The water outlet 16 is located at the top of the support arm 12. The control circuit board 22 is fixed at the upper part of the internal cavity 113, the submersible pump 21 is fixed at the bottom of the internal cavity 113, and the water spray port of the submersible pump 21 is connected with the water outlet 16 through a connecting pipe 25 passing through the internal cavity 113. The water entering the internal cavity 113 through the water inlet 115 is sprayed out of the water outlet 116 by the submersible pump 21.

In this embodiment, the floating body contains an annular foam unit 13 with a central through-hole 132, the main housing 11 is fastened to the annular foam unit 13 with a plurality of support feet 18. At least part of the main housing 11 passes through the second central through-hole 132 of the annular foam unit 13. Thus the water inlet 115 on the main housing 11 is under the water surface.

Preferably, as shown in FIG. 9, the top of each support arm 12 is provided with a mounting slot 1111. The support arm 12 is provided with a light-emitting module 17 powered by the control circuit board 22 and emitting light towards the mounting slot 1111. The part of the mounting slot 1111 toward the support arm 12 on the power generation module 30 is formed with transparent or translucent materials, so that the light emitted by the light-emitting module 17 can shine on the top, forming a better landscape effect.

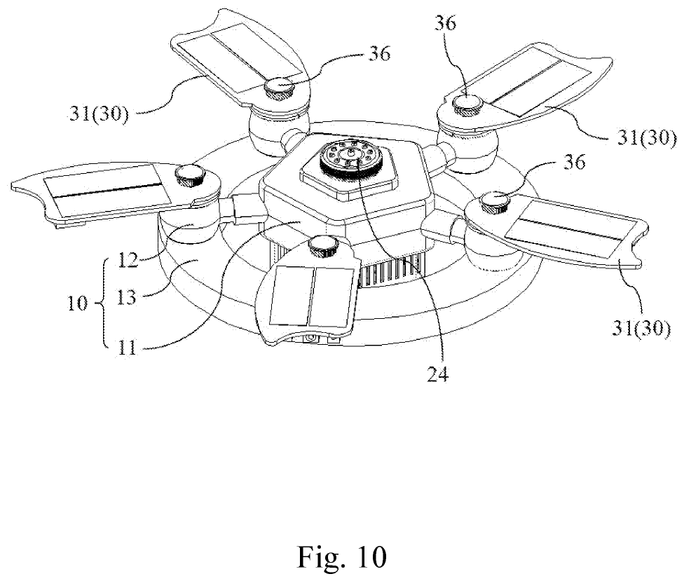

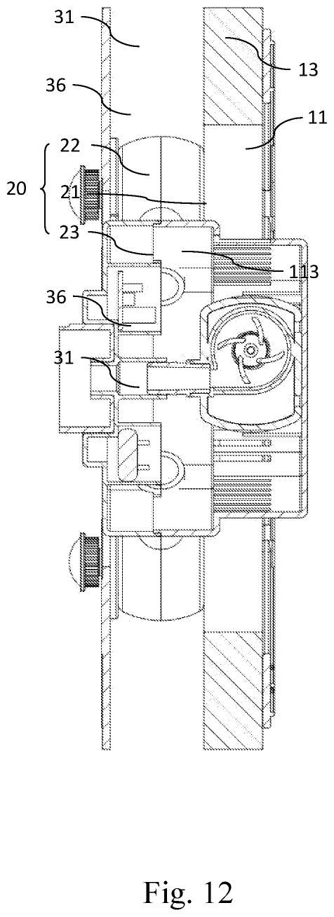

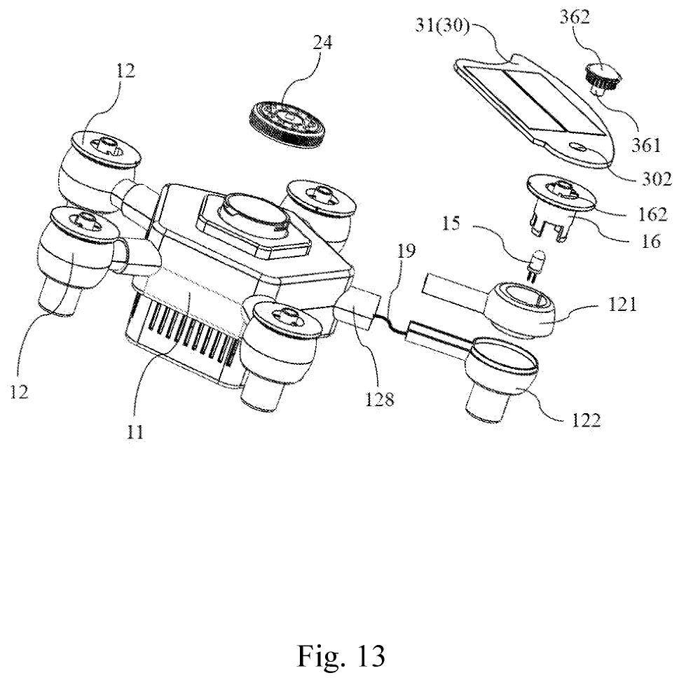

FIGS. 10-13 show a schematic diagram of the floating waterscape apparatus according to another embodiment of the present disclosure. The floating waterscape apparatus in this embodiment also includes a floating body 10, a water spraying component 20, and a plurality of power generation modules 30. Each power generation module 30 includes one first photovoltaic unit 31, that is each first photovoltaic unit 31 forms one power generation module 30. The water spraying component 20 and the first photovoltaic units 31 are respectively assembled to the floating body 10. The floating waterscape apparatus includes five independent power generation modules 30, that is, the floating waterscape apparatus includes five independent first photovoltaic units 31. In other embodiments, the number of power generation modules 30 can be configured according to the size of the floating body 10 and the size of a single first photovoltaic unit 31.

Each first photovoltaic unit 31 is assembled to the floating body 10 through a pivot joint 36. Specifically, each pivot joint 36 includes a pivot part 361. When the first photovoltaic unit 31 is assembled to the floating body 10, its location on the floating body 10 can be adjusted by rotating around the fixed position of the power generation module and the floating body, such as the pivot part 361.

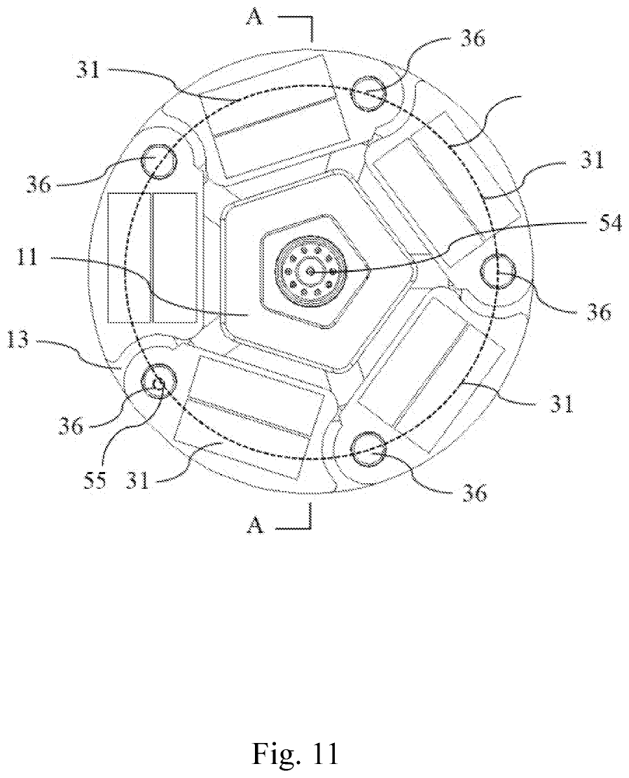

Because all first photovoltaic units 31 can rotate relatively, the floating waterscape apparatus has more shapes. Moreover, by adjusting the location of the first photovoltaic unit 31, the floating waterscape apparatus can be applied to different applications. For example, As the floating waterscape apparatus applied to the bird bath tray, all first photovoltaic units 31 can be folded above the floating body 11, as shown in FIG. 11. As the floating waterscape apparatus applied to a large pool, all first photovoltaic unit 31 can be rotated to keep it away from the floating body 10, as shown in FIG. 10.

In another embodiment, when all first photovoltaic units 31 rotate around the pivot joints 36, there is a state in which all first photovoltaic units 31 are forming a ring, as shown in FIG. 11. Moreover, the rotation center 55 of the pivot part 361 of each pivot joint 36 is located on the same cylindrical surface centered on the central axis of the floating body 10. The rotation centers 55 of the plurality of pivot parts 361 are respectively parallel to the central axis of the floating body 10. The floating body 10 have a limiting structure 162. For example, the limiting structure 162 can use a block located on the rotation path of the pivot joints 36 or the power generation modules 30. Each first photovoltaic units 31 rotates between a first location and a second location by the limiting structure 162. In the first location, the first photovoltaic unit 31 is above the floating body 10. Moreover, as shown in FIG. 11, when all first photovoltaic units 31 are in the first location, all first photovoltaic units 31 are forming a ring. when all first photovoltaic units 31 are in the second location, all first photovoltaic units 31 protrude from the periphery of the floating body, as shown in FIG. 10.

Preferably, the floating body 10 comprises a main housing 11 and a plurality of support arms 12. The central axis of the main housing 11 constitutes the central axis of the floating body 10. The plurality of support arms 12 protrude from the outer circumference of the main housing 11. The plurality of first photovoltaic units 31 are respectively assembled on the plurality of support arms 12 through a plurality of pivot joints 36. In articular, each first photovoltaic unit 31 can be located in the same plane or in different planes.

Similarly, each support arm 12 includes a fixed arm 128, a lower arm shell 122 and an upper arm shell 121. The fixed arm 128 is integrated with the main housing 11. The lower arm shell 122 and the upper arm shell 121 are connected to the end of the fixed arm 128 away from the main housing 11. The lower arm shell 122 and the upper arm shell 121 are assembled together and form a channel for cables 19 to pass through. In addition, in order to improve the visual effect, LED beads 15 and fixed bases 16 for fixing LED beads 15 are also set on the support arms 12. The fixed bases 16 are mounted and fixed on the upper shell 121 of the support arm by buckles. The LED beads 15 are fixed in the fixed bases 16 by potting and powered by the first photovoltaic units 31.

The top of each fixed bases 16 is provided with a vertical mounting hole. Accordingly, each pivot joint 36 includes a top cover 362 connected to the top of the pivot part 361. The pivot part 361 can be hollow and tubular, and the top cover 362 are formed with transparent or translucent materials. Each power generation module 30 includes a pivot hole 302. The pivot part 361 of the pivot joint 36 passes through the pivot hole 302 and is inserted into the mounting hole on the fixed base 16, so as to assemble the power generation module 30 onto the support arm 12. The light emitted by the LED bead 15 can pass through the mounting hole and the pivot part 361 and penetrate from the top cover part 362, presenting a good visual effect.

In other embodiments, each support arm 12 may also adopt an integrated structure, and a mounting hole is set on its top for mounting the first photovoltaic unit 31.

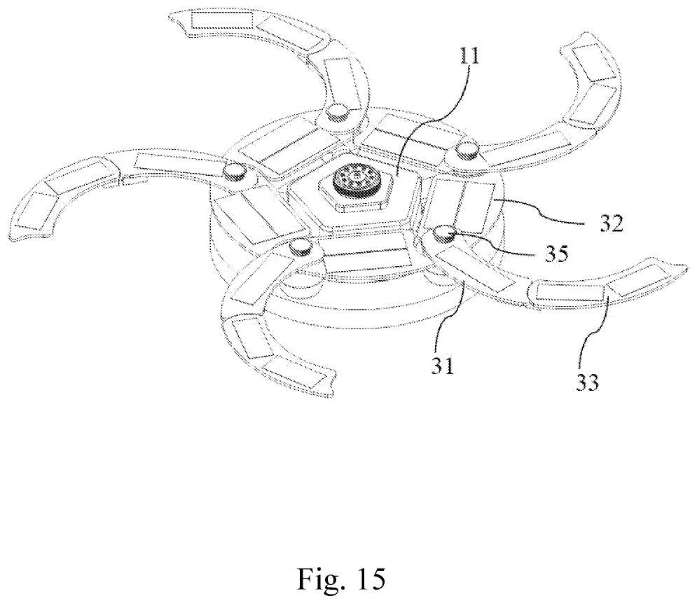

As shown in FIG. 15, the main housing 11 of the floating body 10 includes an upper shell 111 and a lower shell 112. The upper shell 111 is assembled with the lower shell 112 and an internal cavity 113 is formed between the upper shell 111 and the lower shell 112. The main housing 11 includes a water inlet 115 and a water outlet 116 which are connected with internal cavity 113. When the floating body 11 is placed in the water, the water outlet 116 is above the water surface and the water inlet 115 is below the water surface.

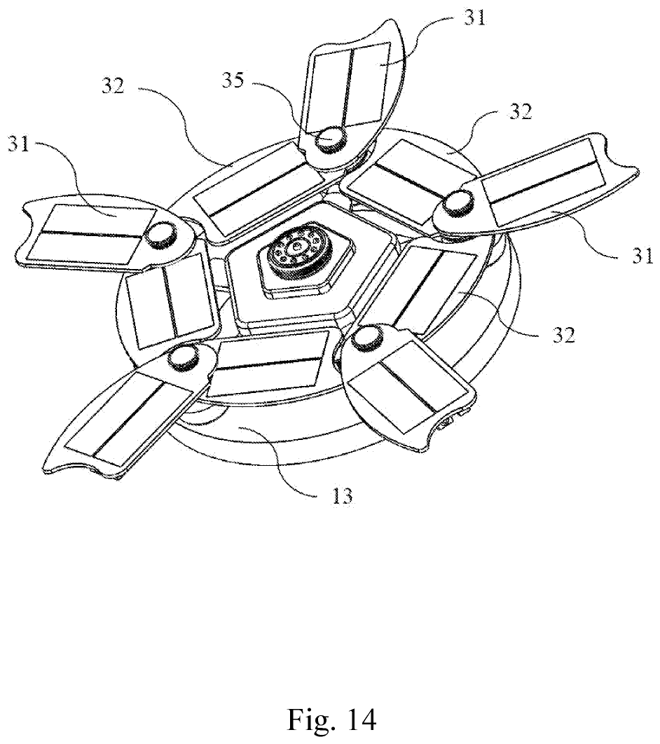

As shown in FIG. 14, in another embodiment, several the power generation modules 30 include a second photovoltaic unit 32 in addition to the first photovoltaic unit 31. Each second photovoltaic unit 32 mounts on the floating body 10 and includes a photovoltaic cell electrically connected to the water spraying component 20 and supplied power to the water spraying component 20. When the floating body 10 is placed in the water, the plane of the photovoltaic cell of the second photovoltaic unit 32 is located above and parallel to the water surface. By the second photovoltaic unit 32, the illumination area of the floating waterscape apparatus can be increased and more powered can be supplied to the water spraying component 20. Thus a better water spray effect will be presented.

The second photovoltaic unit 32 can be fixed or rotated in the same way as the first photovoltaic unit 31. For example, each second photovoltaic unit 32 is assembled to the same position of the floating body 10 with one first photovoltaic unit 31 through the same pivot joint 36. Thus, the second photovoltaic unit 32 and the first photovoltaic unit 31 can be overlapped, and present more shapes.

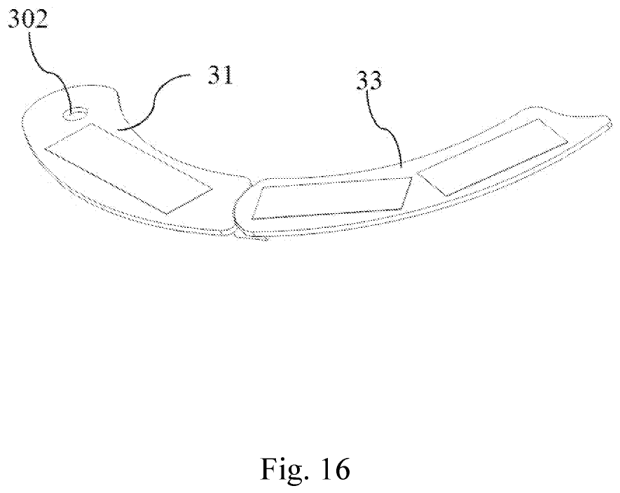

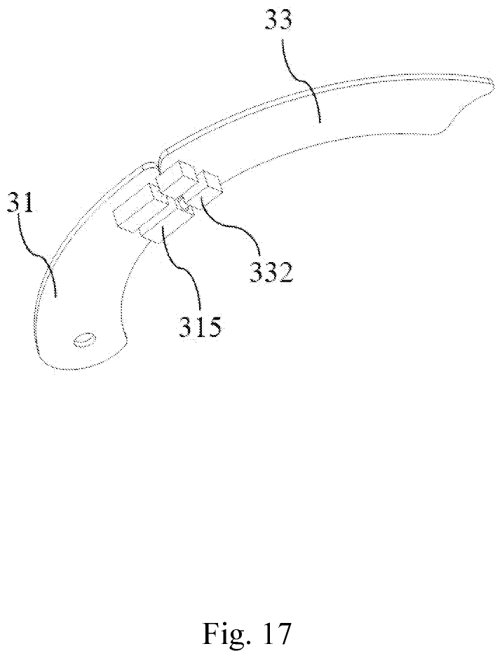

As shown in FIGS. 15-17, in another embodiment, the power generation modules 30 include a number of third photovoltaic units 33 in addition to the first photovoltaic units 31. Each third photovoltaic unit 33 includes a first interface 332. Accordingly, part of the first photovoltaic units 31 include a second interface 315. Each third photovoltaic unit 33 is assembled to one first photovoltaic unit 31 by the first interface 332 joining with the second interface 315. The first photovoltaic unit 31 is electrically connected with the third photovoltaic unit 33 by the first interface 332 and the second interface 315. Thus the third photovoltaic unit 33 can supply power to the water spraying component 20. When the floating body 10 is placed in the water, the plane of the photovoltaic cell on the third photovoltaic unit 33 is located above and parallel to the water surface.

Moreover, the second interface 315 of each first photovoltaic unit 31 is located on the bottom surface of the first photovoltaic unit 31 and away from the pivot joint 36. Meanwhile, in order to improve the mechanical strength of the connection between the first photovoltaic unit 31 and the third photovoltaic unit 33, the first interface 332 and the second interface 315 can adopt a dual-terminal structure.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

1. A floating waterscape apparatus comprising:
a floating body;
at least one power generation module, each of which comprising at least one first photovoltaic unit for converting light energy into electric energy, wherein the first photovoltaic unit protrudes from the floating body and has a gap with the floating body when the power generation module is installed on the floating body;
a water spraying component, which being installed on the floating body and powered by the first photovoltaic unit directly or indirectly, wherein the floating body causes at least part of the first photovoltaic units to be above the water surface and at least part of the water spraying component to be below the water surface when the floating body is placed in the water.

2. The floating waterscape apparatus according to claim 1, wherein the floating waterscape apparatus contains a plurality of power generation modules; wherein the floating body comprises a main housing and a plurality of support arms protruding from the outer circumference of the main housing, and the number of the support arms is greater than or equal to the number of the power generation modules; wherein each of the power generation module is assembled on one support arm through a fastener.

3. The floating waterscape apparatus according to claim 2, wherein the main housing contains an internal cavity, a water inlet and a water outlet, and the water inlet and the water outlet are joined with the internal cavity respectively, wherein the water outlet is above the water surface and the water inlet is below the water surface when the floating body is placed in the water;
wherein the water spraying component comprises a control circuit board and a submersible pump, and the submersible pump and the first photovoltaic unit are electrically connected with the control circuit board respectively; wherein the submersible pump and the control circuit board are installed in the internal cavity of the main housing, and the water entering the internal cavity through the water inlet is sprayed out from the water outlet by the submersible pump.

4. The floating waterscape apparatus according to claim 2, wherein the free end of at least one support arm is provided with a fixed base with LED lamps installed in it, and the top of the fixed base is provided with a vertical mounting hole;
wherein the fastener comprises a rod part and a top cover connected with the top of the rod part; wherein the rod part is hollow and tubular, and the top cover is formed with transparent or translucent materials; each power generation module is provided with a through hole, and the fastener assembles the power generation module to the support arm by the rod part passing through the through hole and inserting into the mounting hole on the fixed base when the power generation module is put on the fixed base.

5. The floating waterscape apparatus according to claim 2, wherein the floating body contains an annular foam unit with a central through-hole, and the annular foam unit is fixed under the support arms, and a part of the main housing passes through the central through-hole of the annular foam unit.

6. The floating waterscape apparatus according to claim 1, wherein the floating waterscape apparatus contains one power generation module, and the first photovoltaic unit is annular; alternatively, the floating waterscape apparatus comprises a plurality of power generation modules, and the first photovoltaic units of the plurality of power generation modules are spliced into a ring.

7. The floating waterscape apparatus according to claim 1, wherein the floating waterscape apparatus contains one power generation component;
wherein the floating body comprises one main housing and one support arm protruding from the top of the main housing, and the power generation module is assembled on the top of the support arm.

8. The floating waterscape apparatus according to claim 7, wherein the main housing contains an internal cavity, a water inlet and a water outlet, and the water inlet and the water outlet are joined with the internal cavity respectively; wherein the water outlet is above the water surface and the water inlet is below the water surface when the floating body is placed in the water;
wherein the water spraying component is installed in the internal cavity of the main housing, and the water entering the internal cavity through the water inlet is sprayed out from the water outlet by the water spraying component.

9. The floating waterscape apparatus according to claim 8, wherein the floating body contains an annular foam unit with a central through-hole, the main housing is fastened to the annular foam unit with a plurality of support feet, and a part of the main housing passes through the central through-hole of the annular foam unit.

10. The floating waterscape apparatus according to claim 1, wherein each power generation module contains a plurality of first photovoltaic units, and the plurality of first photovoltaic units are radially distributed around the fixed position of the power generation module and the floating body.

11. The floating waterscape apparatus according to claim 1, wherein the floating waterscape apparatus contains a plurality of power generation modules and a plurality of pivot connectors;
wherein each of the power generation components is assembled to the floating body through one of the pivot connectors; each pivot connector includes a pivot part, and the first photovoltaic unit of each power generation module adjusts its position by rotating around the pivot part of the pivot connector.

12. The floating waterscape apparatus according to claim 11, wherein the floating body is provided with a limiting structure, which limits the power generation module swinging between a first position and a second position, wherein the first photovoltaic unit is stacked above the floating body when the power generation module is at the first position, and the first photovoltaic unit is protruded from the periphery of the floating body when the power generation module is at the second position.

13. The floating waterscape apparatus according to claim 11, wherein the floating body includes a main housing and a plurality of support arms protruding from the outer circumference of the main housing, and each of the power generation modules is assembled on one of the support arm through a pivot connector.

14. The floating waterscape apparatus according to claim 13, wherein the main housing contains an internal cavity, a water inlet and a water outlet, and the water inlet and the water outlet are joined with the internal cavity respectively; wherein the water outlet is above the water surface and the water inlet is below the water surface when the floating body is placed in the water;
wherein the water spraying component is installed in the internal cavity of the main housing, and the water entering the internal cavity through the water inlet is sprayed out from the water outlet by the water spraying component.

15. The floating waterscape apparatus according to claim 13, wherein the rotation center of the pivot part of each pivot connector is located on the same cylindrical surface centered on the central axis of the main housing, and the rotation centers of the pivot parts of the plurality of the pivot connectors are respectively parallel to the central axis of the main housing.

16. The floating waterscape apparatus according to claim 11, wherein at least one of the power generation modules contains a second photovoltaic unit assembled on the floating body;
wherein each of the second photovoltaic units includes a second photovoltaic cell that supplies power to the water spraying component, and the second photovoltaic cell is above and parallel to the water surface when the floating body is placed in the water.

17. The floating waterscape apparatus according to claim 16, wherein each second photovoltaic unit and one first photovoltaic unit are assembled to the same position of the floating body through a same pivot connector.

18. The floating waterscape apparatus according to claim 11, wherein at least one of the power generation modules includes a third photovoltaic unit, and each third photovoltaic unit contains a first interface;
wherein at least one of the first photovoltaic units includes a second interface, and each third photovoltaic unit is assembled to one first photovoltaic unit through the first interface and the second interface, the third photovoltaic unit supplies power to the water spraying module through the first interface and the second interface.

19. The floating waterscape apparatus according to claim 11, wherein the free end of at least one support arm is provided with a fixed base with LED lamps installed in it, and the top of the fixed base is provided with a vertical mounting hole;
wherein each pivot connector comprises a rod part and a top cover on the top of the rod part; wherein the rod part is hollow and tubular, and the top cover is formed with transparent or translucent materials; each power generation module is provided with a through hole, and the pivot connector assembles the power generation module to the support arm by the rod part passing through the through hole and inserting into the mounting hole on the fixed base.

20. The floating waterscape apparatus according to claim 11, wherein the floating body contains an annular foam unit with a central through-hole, and the annular foam unit is fixed under the support arms, and a part of the main housing passes through the central through-hole of the annular foam unit.
